(19) United States
(12) Patent Application Publication
(10) Pub. No.: US 2026/0231197 A1
(43) Pub. Date: Aug. 6, 2026

(54) RESOURCE ALLOCATION FOR UPLINK JOINT COMMUNICATION AND SENSING

(71) Applicant: QUALCOMM Incorporated, San Diego, CA (US)

(72) Inventors: Preeti KUMARI, San Diego, CA (US); Kapil GULATI, Belle Mead, NJ (US); Shijun WU, San Diego, CA (US); Stelios STEFANATOS, San Diego, CA (US); Junyi LI, Greentown, PA (US)

(21) Appl. No.: 19/150,936

(22) PCT Filed: Mar. 14, 2024
(86) PCT No.: PCT/US2024/019909

§ 371 Date: Jul. 25, 2025

(30) Foreign Application Priority Data
Mar. 22, 2023 (GR) 20230100234

(51) Int. Cl. H04W 72/51; H04W 64/00; H04W 72/044

(52) U.S. Cl. CPC H04W 72/51; H04W 64/006; H04W 72/046

(57) ABSTRACT

Various aspects of the present disclosure generally relate to wireless communication. In some aspects, a user equipment (UE) may receive a first grant of resources allocating a plurality of scanning directions and a first plurality of tracking directions. The UE may transmit a resource modification request. The UE may receive a second grant of resources allocating a second plurality of tracking directions, wherein the second plurality of tracking directions is a subset of the plurality of scanning directions different from the first plurality of tracking directions. Numerous other aspects are described.

### CROSS-REFERENCE TO RELATED APPLICATION

This Patent Application claims priority to Greek Patent Application No. 20230100234, filed on Mar. 22, 2023, entitled “ACTIVE TIME EXTENSION FOR BEAM FAILURE DETECTION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for resource allocation for uplink joint communication and sensing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive a first grant of resources allocating a plurality of scanning directions and a first plurality of tracking directions. The one or more processors may be configured to transmit a resource modification request. The one or more processors may be configured to receive a second grant of resources allocating a second plurality of tracking directions, wherein the second plurality of tracking directions is a subset of the plurality of scanning directions different from the first plurality of tracking directions.

Some aspects described herein relate to a network entity for wireless communication. The network entity may include a memory and one or more processors coupled to the memory. The one or more processors may be configured to output or configure a first grant of resources allocating a plurality of scanning directions and a first plurality of tracking directions. The one or more processors may be configured to receive a resource modification request. The one or more processors may be configured to output or configure a second grant of resources allocating a second plurality of tracking directions, wherein the second plurality of tracking directions is a subset of the plurality of scanning directions different from the first plurality of tracking directions.

Some aspects described herein relate to a method of wireless communication performed by a UE. The method may include receiving a first grant of resources allocating a plurality of scanning directions and a first plurality of tracking directions. The method may include transmitting a resource modification request. The method may include receiving a second grant of resources allocating a second plurality of tracking directions, wherein the second plurality of tracking directions is a subset of the plurality of scanning directions different from the first plurality of tracking directions.

Some aspects described herein relate to a method of wireless communication performed by a network entity. The method may include outputting or configuring a first grant of resources allocating a plurality of scanning directions and a first plurality of tracking directions. The method may include receiving a resource modification request. The method may include outputting or configuring a second grant of resources allocating a second plurality of tracking directions, wherein the second plurality of tracking directions is a subset of the plurality of scanning directions different from the first plurality of tracking directions.

Some aspects described herein relate to a non-transitory computer-readable medium that stores a set of instructions for wireless communication by a UE. The set of instructions, when executed by one or more processors of the UE, may cause the UE to receive a first grant of resources allocating a plurality of scanning directions and a first plurality of tracking directions. The set of instructions, when executed by one or more processors of the UE, may cause the UE to transmit a resource modification request. The set of instructions, when executed by one or more processors of the UE, may cause the UE to receive a second grant of resources allocating a second plurality of tracking directions, wherein the second plurality of tracking directions is a subset of the plurality of scanning directions different from the first plurality of tracking directions.

Some aspects described herein relate to a non-transitory computer-readable medium that stores a set of instructions for wireless communication by a network entity. The set of instructions, when executed by one or more processors of the network entity, may cause the network entity to output or configure a first grant of resources allocating a plurality of scanning directions and a first plurality of tracking directions. The set of instructions, when executed by one or more processors of the network entity, may cause the network entity to receive a resource modification request. The set of instructions, when executed by one or more processors of the network entity, may cause the network entity to output or configure a second grant of resources allocating a second plurality of tracking directions, wherein the second plurality of tracking directions is a subset of the plurality of scanning directions different from the first plurality of tracking directions.

Some aspects described herein relate to an apparatus for wireless communication. The apparatus may include means for receiving a first grant of resources allocating a plurality of scanning directions and a first plurality of tracking directions. The apparatus may include means for transmitting a resource modification request. The apparatus may include means for receiving a second grant of resources allocating a second plurality of tracking directions, wherein the second plurality of tracking directions is a subset of the plurality of scanning directions different from the first plurality of tracking directions.

Some aspects described herein relate to an apparatus for wireless communication. The apparatus may include means for outputting or configuring a first grant of resources allocating a plurality of scanning directions and a first plurality of tracking directions. The apparatus may include means for receiving a resource modification request. The apparatus may include means for outputting or configuring a second grant of resources allocating a second plurality of tracking directions, wherein the second plurality of tracking directions is a subset of the plurality of scanning directions different from the first plurality of tracking directions.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of scanning and tracking phases, in accordance with the present disclosure.

FIG. 5 is a diagram illustrating an example of resource allocation for scanning and tracking phases, in accordance with the present disclosure.

FIG. 6 is a diagram illustrating an example associated with resource allocation for uplink joint communication and sensing, in accordance with the present disclosure.

FIG. 7 is a diagram illustrating an example process performed, for example, by a UE, in accordance with the present disclosure.

FIG. 8 is a diagram illustrating an example process performed, for example, by a network entity, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

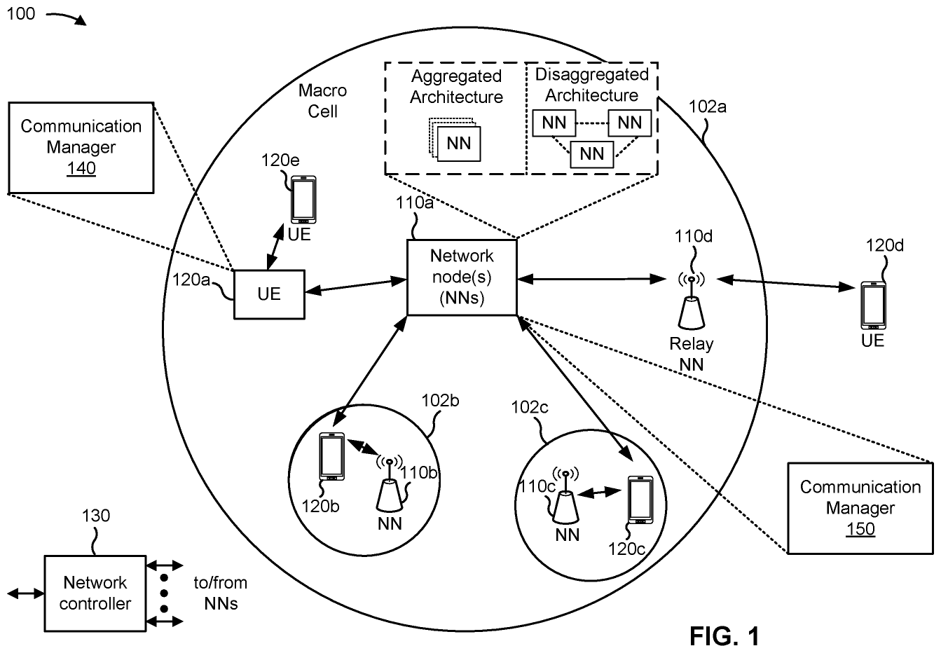

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a first grant of resources allocating a plurality of scanning directions and a first plurality of tracking directions; transmit a resource modification request; and receive a second grant of resources allocating a second plurality of tracking directions, wherein the second plurality of tracking directions is a subset of the plurality of scanning directions different from the first plurality of tracking directions. Additionally, or alternatively, the communication manager 140 may perform one or more other operations described herein.

In some aspects, the network entity may include a communication manager 150. As described in more detail elsewhere herein, the communication manager 150 may output or configure a first grant of resources allocating a plurality of scanning directions and a first plurality of tracking directions; receive a resource modification request; and output or configure a second grant of resources allocating a second plurality of tracking directions, wherein the second plurality of tracking directions is a subset of the plurality of scanning directions different from the first plurality of tracking directions. Additionally, or alternatively, the communication manager 150 may perform one or more other operations described herein.

As indicated above, FIG. 1 is provided as an example. Other examples may differ from what is described with regard to FIG. 1.

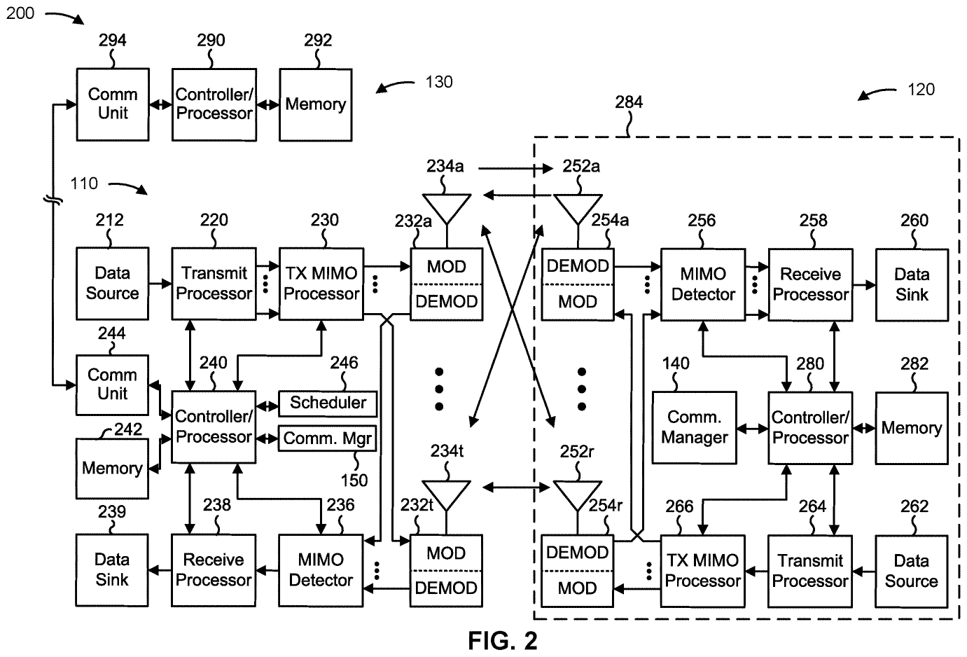

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

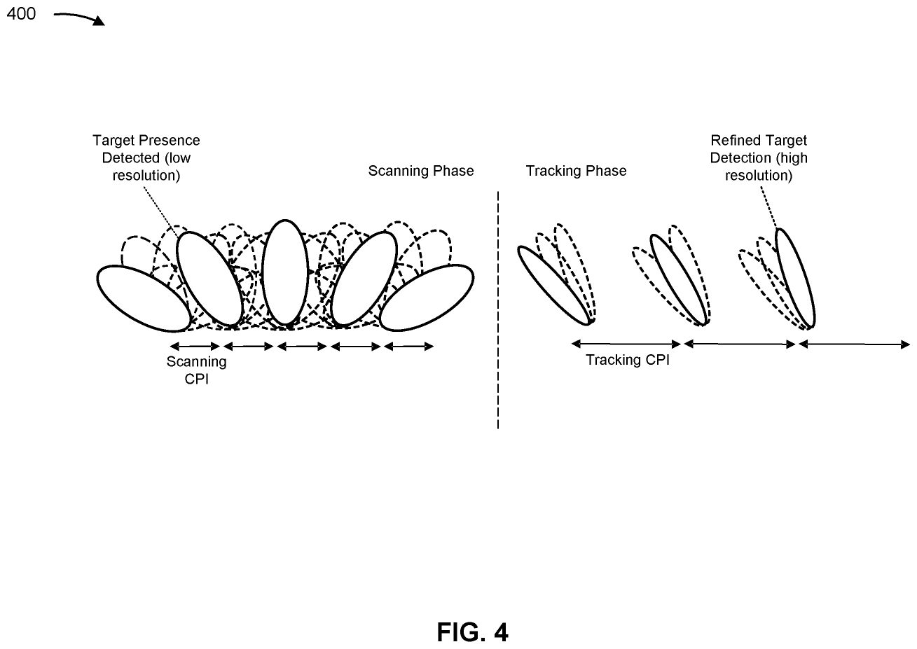

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10.

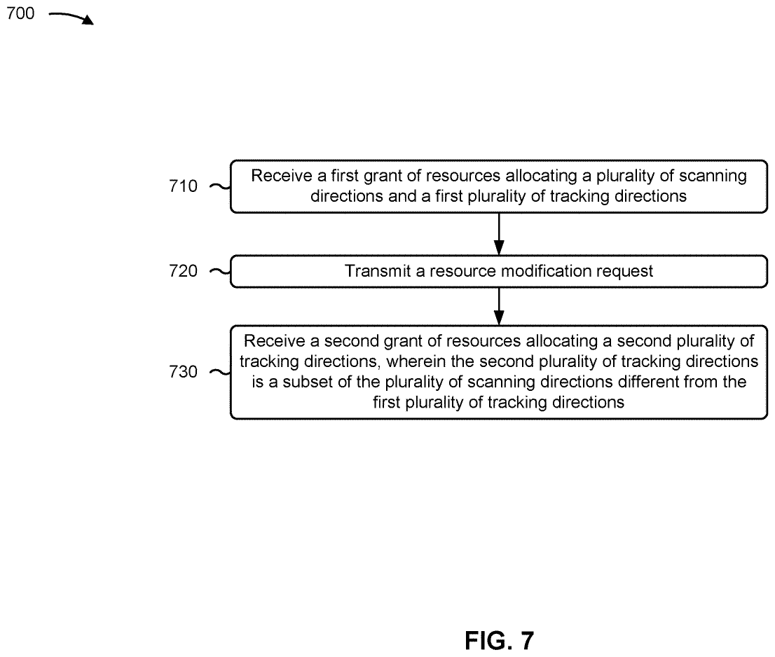

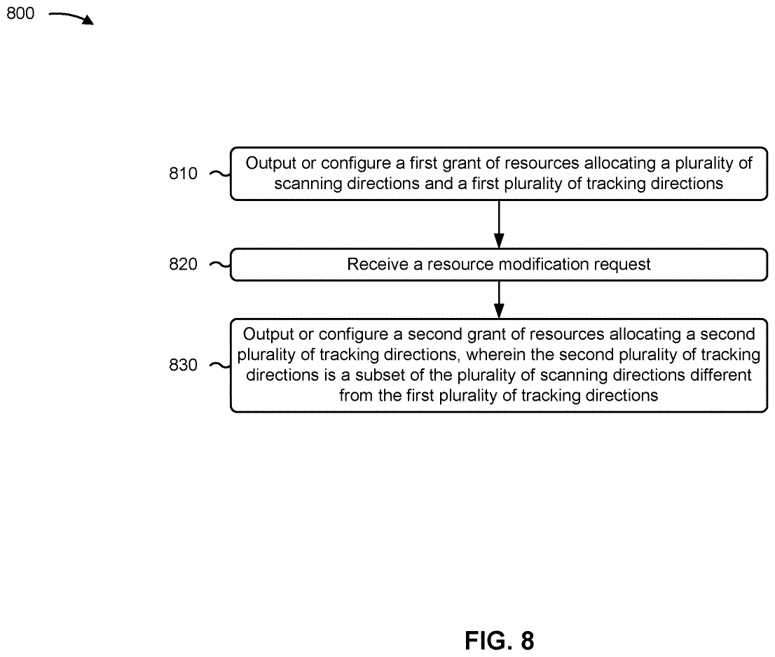

The controller/processor 240 of the network node 110, the controller/processor 280 of the UE 120, and/or any other component(s) of FIG. 2 may perform one or more techniques associated with resource allocation for uplink joint communication and sensing, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples. In some aspects, the network entity described herein is the network node 110, is included in the network node 110, or includes one or more components of the network node 110 shown in FIG. 2.

In some aspects, the UE 120 includes means for receiving a first grant of resources allocating a plurality of scanning directions and a first plurality of tracking directions; means for transmitting a resource modification request; and/or means for receiving a second grant of resources allocating a second plurality of tracking directions, wherein the second plurality of tracking directions is a subset of the plurality of scanning directions different from the first plurality of tracking directions. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity 110 includes means for outputting or configuring a first grant of resources allocating a plurality of scanning directions and a first plurality of tracking directions; means for receiving a resource modification request; and/or means for outputting or configuring a second grant of resources allocating a second plurality of tracking directions, wherein the second plurality of tracking directions is a subset of the plurality of scanning directions different from the first plurality of tracking directions. In some aspects, the means for the network entity 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

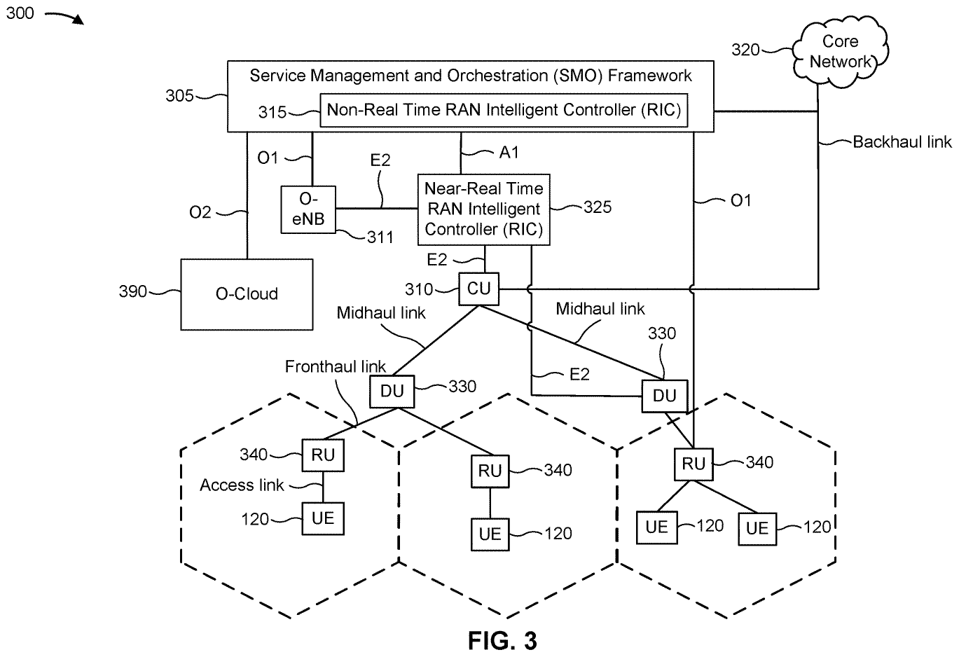

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of scanning and tracking phases, in accordance with the present disclosure.

Joint communication and radar (JCR) systems can be categorized as cooperative JCR systems or co-design JCR systems. In a cooperative JCR system, each UE has a radar transceiver and a communication transceiver. Information is shared between each radar transceiver and each communication transceiver, even among multiple UEs. Accordingly, the radar transceiver of one UE may share information with the communication transceiver of the same UE as well as with the radar transceiver and/or the communication transceiver of another UE. Moreover, the communication transceiver of one UE may share information with the radar transceiver of the same UE as well as with the radar transceiver and/or the communication transceiver of another UE. This approach generally allows spectrum reuse and ease of implementation. In a co-design JCR system, each UE includes a common transmitter or receiver used for both communication and radar functionality (called a JCR transceiver). The JCR transceiver of one UE may communicate with the JCR transceiver of another UE. A benefit of this approach includes hardware and spectrum reuse.

In one example, vehicle UEs can use JCR systems to sense for surrounding objects. For example, to enable UE-side JCR sensing, uplink (UL) resources can be used for both communication and sensing. In one aspect, separate resources may be allocated for communication and radar modes. For instance, a sounding reference signal (SRS) can be used as a sensing waveform. In one aspect, the same resource can be used for both communication and radar with a joint-co-design waveform.

One way to share UL resources during scanning and tracking is with two-stage sensing, as illustrated in FIG. 4. As shown, a scanning phase occurs prior to a tracking phase. During both the scanning phase and the tracking phase, a vehicle UE may output multiple beams in different directions. The beams in solid lines indicate the detection of a target object. The beams in dashed lines indicate that no target was detected. The beams output during the scanning phase (i.e., “scanning beams”) may have a lower resolution than the beams output during the tracking phase (i.e., “tracking beams”). For example, the scanning beams may have a coherent processing interval (CPI), also referred to as a radar frame, of 1 ms, a bandwidth of 150 MHz, and a subcarrier signal (SCS) of 120 kHz. The tracking beams may be higher resolution than the scanning beams. For instance, the tracking beams may have a CPI of 5 ms and a bandwidth of 0.5 GHz. Further, the directions of the tracking beams may be based at least in part on the presence of targets identified by the scanning beams. For example, the tracking beams may be output toward one or more targets identified by the scanning beam. Therefore, in some aspects, the vehicle UE may output fewer tracking beams than scanning beams in a single scanning and tracking phase.

As indicated above, FIG. 4 is provided as an example. Other examples may differ from what is described with respect to FIG. 4.

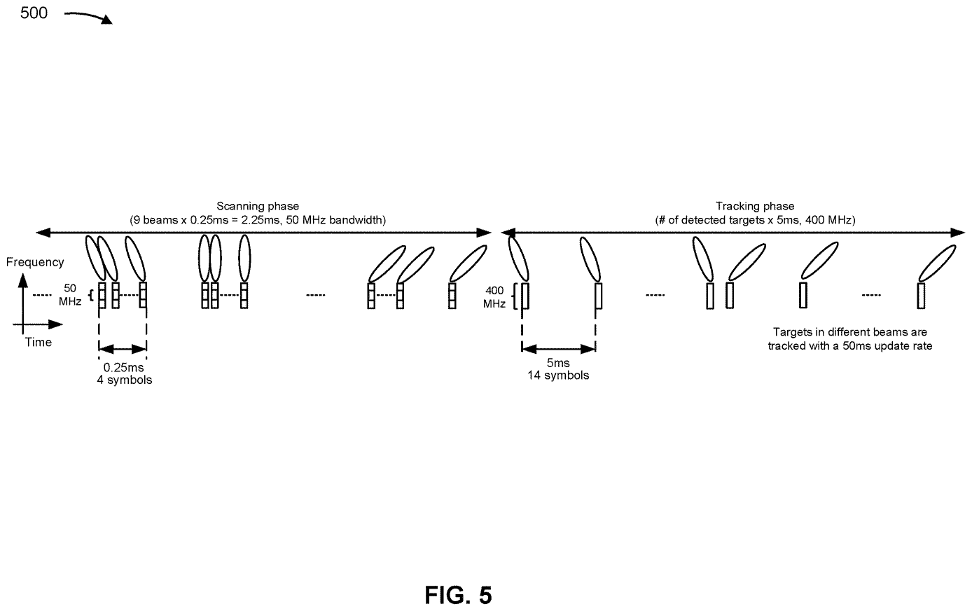

FIG. 5 is a diagram illustrating an example 500 of resource allocation for scanning and tracking phases, in accordance with the present disclosure.

As shown in FIG. 5, the scanning phase includes nine scanning beams for low resolution scanning. Each scanning beam, in the example 500, is transmitted by a vehicle UE at a bandwidth of 50 MHz. Scanning may occur at a rate of 0.25 ms per beam with 4 symbols occurring between each scanning beam.

In the example 500, six targets are identified during the scanning phase. Accordingly, the vehicle UE directs tracking beams toward the six targets during the tracking phase. The vehicle UE may output each tracking beam for 5 ms toward each of the identified targets. The bandwidth of each tracking beam may be 400 MHz. Scanning may occur at a rate of 5 ms per target with 14 symbols between each scanning beam.

As indicated above, FIG. 5 is provided as an example. Other examples may differ from what is described with respect to FIG. 5.

In two-stage sensing implementations, such as those illustrated in examples 400 and 500 of FIGS. 4-5, resources for the scanning phase can be predetermined. For example, the vehicle UE may be configured to scan in all beam directions with low time-frequency resource overhead. Allocating resources for the tracking phase can be more difficult. For example, if the initial configuration grant for tracking resources is too conservative, radar performance will be limited. Therefore, additional resources may be required to track all detected objects. Further, if the initial resource allocation for the tracking phase is based on the prior probability of target information, radar performance may be limited due to the accuracy of that prior probability of target information. Therefore, new targets outside the initial grant may need to be tracked with additional resource scheduling. Alternatively or in addition, resources for targets that no longer need to be tracked will need to be canceled.

Some techniques and apparatuses described herein enable a UE to receive a first grant of resources allocating a plurality of scanning directions and a first plurality of tracking directions; transmit a resource modification request; and receive a second grant of resources allocating a second plurality of tracking directions, wherein the second plurality of tracking directions is a subset of the plurality of scanning directions different from the first plurality of tracking directions. As a result, the UE can request a modification of the tracking resources (from, e.g., the first plurality of tracking directions to the second plurality of tracking directions) based on the number of targets identified during the scanning phase, thereby increasing the likelihood that the appropriate number of tracking resources are allocated to properly track all identified objects.

Some techniques and apparatuses described herein enable a network entity to output or configure a first grant of resources allocating a plurality of scanning directions and a first plurality of tracking directions; receive a resource modification request; and output or configure a second grant of resources allocating a second plurality of tracking directions, wherein the second plurality of tracking directions is a subset of the plurality of scanning directions different from the first plurality of tracking directions. As a result, the network entity may grant the appropriate number of tracking resources (from, e.g., the first plurality of tracking directions to the second plurality of tracking directions) based on the number of targets identified by the UE during the scanning phase. In doing so, the network entity increases the likelihood that the tracking resources are appropriately allocated, which can improve network performance by reducing the number of requests for resource reallocation from the UE.

Even though the second plurality of tracking directions is different from the first plurality of tracking directions, the first plurality of tracking directions and second plurality of tracking directions may have one or more of the same tracking directions, one or more different tracking directions, and/or a combination thereof. Accordingly, in some aspects, “different from” may mean that at least one of the tracking directions in the first plurality of tracking directions is not included in the second plurality of tracking directions or that at least one of the tracking directions in the second plurality of tracking directions is not included in the first plurality of tracking directions.

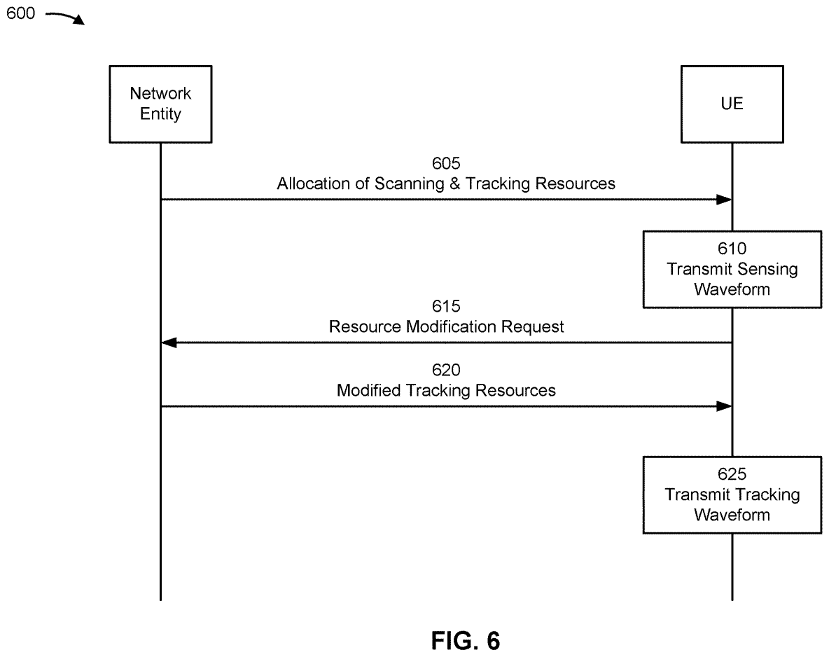

FIG. 6 is a diagram illustrating an example 600 associated with resource allocation for uplink joint communication and sensing, in accordance with the present disclosure. As shown in FIG. 6, a network entity, such as network node 110, and a UE, such as UE 120, may communicate with one another.

As shown by reference number 605, the network entity may output, and the UE may receive, a first grant of resources that, for example, allocates scanning and tracking resources. In some aspects, the first grant of resources allocates a plurality of scanning directions for a scanning phase of two-stage JCR and a plurality of tracking directions for a tracking phase of two-stage JCR. In some aspects, the scanning phase includes sensing in N (e.g., 9) beam directions with frame 1 associated with beam 1, frame 2 associated with beam 2, frame 9 associated with beam 9, and so on. In some aspects, the first grant of resources includes the tracking directions as a subset of the scanning directions. For example, the tracking phase may include sensing in the first K frames (e.g., 3 frames) with each frame associated with a given beam direction. For instance, first frame sensing may occur in beam 1, second frame sensing may occur in beam 2, and third frame sensing may occur in beam 3. In some aspects, beams 1, 2, and 3 may be the most likely beam directions for a target to be present.

In some aspects, the tracking phase may include sensing in the first K frames (e.g., 4 frames) with each frame associated with a set of beam directions, where only one beam is picked per frame by the UE. In some aspects, a beam direction may be allocated only to one frame. For example, first frame sensing may occur in beams 1 or 9; second frame sensing may occur in beam 2; third frame sensing may occur in beams 3 or 7; and fourth frame sensing may occur in beam 4. In some aspects, the beam direction in a given frame may be chosen based on a priority order of the targets of those beams. The priority of a target may be based on the detection and estimation performance of the target, the direction and location of the target, and/or a combination thereof, or the like. In some aspects, a beam direction is allocated more than one frame. For example, first frame sensing may occur in either beams 1, 3, or 5; second frame sensing may occur in either beams 2 or 6; third frame sensing may occur in beam 5; and fourth frame sensing may occur in either beams 4 or 2. In some aspects, a frame and beam direction pair may be chosen based on the probability of a target leaving the beam earliest. For instance, tracking a target traveling at a high velocity may need low latency tracking with an early frame allocation.

As shown by reference number 610, the UE may transmit a sensing waveform using the allocated resources for the scanning phase, including the scanning directions. The sensing waveform may be used to detect nearby targets via, e.g., a bistatic sensing procedure. In some aspects, the UE processes data received as a result of transmitting the sensing waveform to perform radar detection and estimation with respect to nearby targets.

As shown by reference number 615, the UE may transmit, and the network entity may receive, a resource modification request. In some aspects, the resource modification request may include the number of targets identified as a result of transmitting the sensing waveform at reference number 610. In some aspects, the resource modification request may include a list of targets with corresponding beam index, estimated location, and estimated velocity information. In some aspects, the resource modification request may identify one or more frame numbers, one or more beam directions, one or more pairs of frame numbers and beam directions, a combination thereof, and/or the like. The resource modification request may include a request to exclude one or more tracking directions from the tracking phase, a request to include one or more tracking directions in the tracking phase, a combination thereof, and/or the like.

In some aspects, resource exclusion may include an indication of which tracking directions are not to be included in a modified resource allocation (also called a second grant of resources). In some aspects, the resource modification request may indicate one or more frame numbers to be excluded from the second grant of resources. For example, the resource modification request may indicate that frames 2 and 3 are to be excluded. In another aspect, the resource modification request may indicate beam numbers to be excluded. For example, the resource modification request may indicate that beams 3, 7, and 9 are to be excluded. In another aspect, the resource modification request may indicate one or more frames and beam pairs to be excluded. For example, the resource modification request may indicate that frame 1 (with beams 3 and 5), frame 2 (with beam 6), and frame 4 (with beam 2) are to be excluded.

In some aspects, resource inclusion may include an indication of additional tracking directions to be allocated in the second grant of resources. This may occur if the initial grant of tracking directions in the first resource grant was too conservative because of, for example, limited information concerning the priority probability of target information. If additional targets have been identified during the scanning phase, the resource modification request may identify additional tracking directions to be included in the second resource grant. In some aspects, multiple tracking phases may need additional resources to accommodate for new target detection and/or estimation in multiple tracking directions.

In some aspects, the resource modification request may include an indication of one or more beams to be included, one or more frame and beam pairs to be included, one or more frames to be included, a combination thereof, and/or the like. For example, the resource modification request may include a beam direction and frame pair (e.g., frame 2 and beam 9). In some aspects, the UE may receive an acknowledgement (ACK) or negative acknowledgement (NACK) to indicate whether the request was accepted or rejected by the network entity. In some aspects, the resource modification request may include an alternative frame with the same beam pair if the beam is not available in the initial frame (e.g., propose frame 3 and beam 6 if beam 6 is not available in frame 2) due to, for example, possible interference or an unavailable resource for that beam and frame pair. In some aspects, the resource modification request may include frame numbers with available beam directions. For instance, the resource modification request may include frame 1 with either beam 2 or beam 6, and frame 2 with either beam 1 or beam 3.

As shown by reference number 620, the network entity may output, and the UE may receive, the second resource grant indicating the modified tracking resources. The second resource grant may exclude or include the resources indicated in the resource modification request. In some aspects, the second resource grant may include a schedule that is based, at least in part, on the output of the scanning phase at reference number 610 (e.g., the results of transmitting the scanning waveform to detect nearby targets using, for example, a bistatic sensing procedure). In some aspects, the second resource grant may be based, at least in part, on resources allocated to other devices with a higher priority than the UE. In some aspects, the second resource grant may be based, at least in part, on reducing potential interference between the UE and other devices. For example, the second resource grant may be based, at least in part, on reducing interference with a new device that entered a coverage area of the network entity after the first grant of resources.

As shown by reference number 625, the UE may transmit the tracking waveform according to the second resource grant indicating the modified tracking resources. The tracking waveform may be used to track the nearby objects identified during the sensing phase. As discussed above, however, the tracking waveform may track objects at a higher resolution than the sensing waveform.

With the foregoing approach, tracking phase resources may be updated following the scanning phase to help the UE better track targets identified during the scanning phase. Otherwise, certain targets may be lost, particularly if the first grant of resources included an insufficient number of tracking directions to track all nearby targets.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with resource allocation for uplink joint communication and sensing.

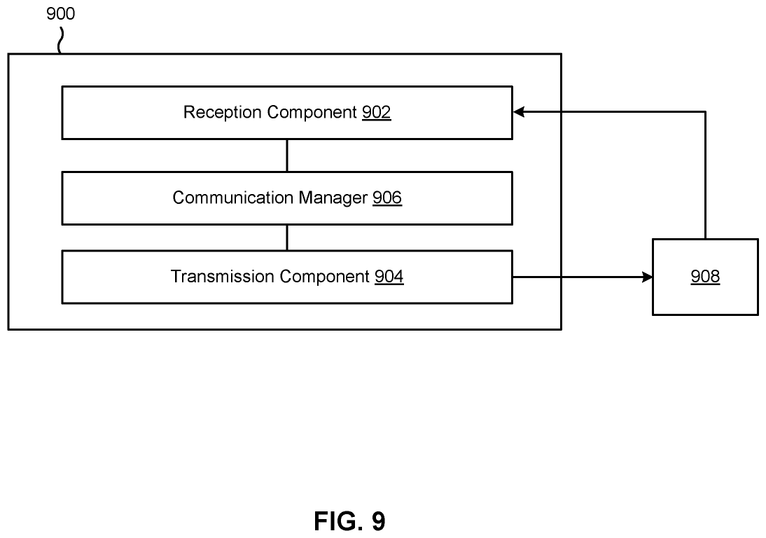

As shown in FIG. 7, in some aspects, process 700 may include receiving a first grant of resources allocating a plurality of scanning directions and a first plurality of tracking directions (block 710). For example, the UE (e.g., using reception component 902 and/or communication manager 906, depicted in FIG. 9) may receive a first grant of resources allocating a plurality of scanning directions and a first plurality of tracking directions, as described above.

As further shown in FIG. 7, in some aspects, process 700 may include transmitting a resource modification request (block 720). For example, the UE (e.g., using transmission component 904 and/or communication manager 906, depicted in FIG. 9) may transmit a resource modification request, as described above.

As further shown in FIG. 7, in some aspects, process 700 may include receiving a second grant of resources allocating a second plurality of tracking directions, wherein the second plurality of tracking directions is a subset of the plurality of scanning directions different from the first plurality of tracking directions (block 730). For example, the UE (e.g., using reception component 902 and/or communication manager 906, depicted in FIG. 9) may receive a second grant of resources allocating a second plurality of tracking directions, wherein the second plurality of tracking directions is a subset of the plurality of scanning directions different from the first plurality of tracking directions, as described above.

Process 700 may include additional aspects, such as any single aspect or any combination of aspects described below and/or in connection with one or more other processes described elsewhere herein.

In a first aspect, process 700 includes transmitting a first sensing waveform in each of the plurality of scanning directions to determine an estimated object location.

In a second aspect, alone or in combination with the first aspect, process 700 includes generating the resource modification request based at least in part on the estimated object location.

In a third aspect, alone or in combination with one or more of the first and second aspects, the second plurality of tracking directions includes one or more tracking directions associated with the estimated object location.

In a fourth aspect, alone or in combination with one or more of the first through third aspects, process 700 includes transmitting an indication of a number of targets identified by the first sensing waveform.

In a fifth aspect, alone or in combination with one or more of the first through fourth aspects, process 700 includes transmitting an indication of a list of targets identified by the first sensing waveform.

In a sixth aspect, alone or in combination with one or more of the first through fifth aspects, the indication of the list of targets includes a respective corresponding beam index for each target in the list of targets.

In a seventh aspect, alone or in combination with one or more of the first through sixth aspects, process 700 includes transmitting a respective estimated object location associated with each target of one or more targets identified by the first sensing waveform.

In an eighth aspect, alone or in combination with one or more of the first through seventh aspects, process 700 includes transmitting respective estimated velocity information associated with each target of one or more targets identified by the first sensing waveform.

In a ninth aspect, alone or in combination with one or more of the first through eighth aspects, process 700 includes transmitting a second sensing waveform in each of the second plurality of tracking directions.

In a tenth aspect, alone or in combination with one or more of the first through ninth aspects, the first grant of resources allocates one scanning direction per frame.

In an eleventh aspect, alone or in combination with one or more of the first through tenth aspects, the resource modification request identifies one or more resources, of the first grant of resources, to be excluded from the second grant of resources.

In a twelfth aspect, alone or in combination with one or more of the first through eleventh aspects, the one or more resources to be excluded from the second grant of resources include one or more resources associated with one or more tracking directions of the first plurality of tracking directions.

In a thirteenth aspect, alone or in combination with one or more of the first through twelfth aspects, the resource modification request identifies the one or more resources to be excluded from the second grant of resources according to a frame number.

In a fourteenth aspect, alone or in combination with one or more of the first through thirteenth aspects, the resource modification request identifies the one or more resources to be excluded from the second grant of resources according to a beam number.

In a fifteenth aspect, alone or in combination with one or more of the first through fourteenth aspects, the resource modification request identifies the one or more resources to be excluded from the second grant of resources according to a frame number and beam pair.

In a sixteenth aspect, alone or in combination with one or more of the first through fifteenth aspects, the resource modification request identifies one or more resources, of the first grant of resources, to be included in the second grant of resources.

In a seventeenth aspect, alone or in combination with one or more of the first through sixteenth aspects, the one or more resources to be included in the second grant of resources include one or more resources associated with one or more tracking directions not included in the first plurality of tracking directions.

In an eighteenth aspect, alone or in combination with one or more of the first through seventeenth aspects, the resource modification request identifies the one or more resources to be included in the second grant of resources according to a frame number.

In a nineteenth aspect, alone or in combination with one or more of the first through eighteenth aspects, the resource modification request identifies the one or more resources to be included in the second grant of resources according to a beam number.

In a twentieth aspect, alone or in combination with one or more of the first through nineteenth aspects, the resource modification request identifies the one or more resources to be included in the second grant of resources according to a frame number and beam pair.

In a twenty-first aspect, alone or in combination with one or more of the first through twentieth aspects, the second plurality of tracking directions includes each tracking direction of the first plurality of tracking directions and at least one other tracking direction, of the plurality of scanning directions, not included in the first plurality of tracking directions.

In a twenty-second aspect, alone or in combination with one or more of the first through twenty-first aspects, process 700 includes transmitting a negative acknowledgement prior to transmitting the resource modification request.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., network node 110) performs operations associated with resource allocation for uplink joint communication and sensing.

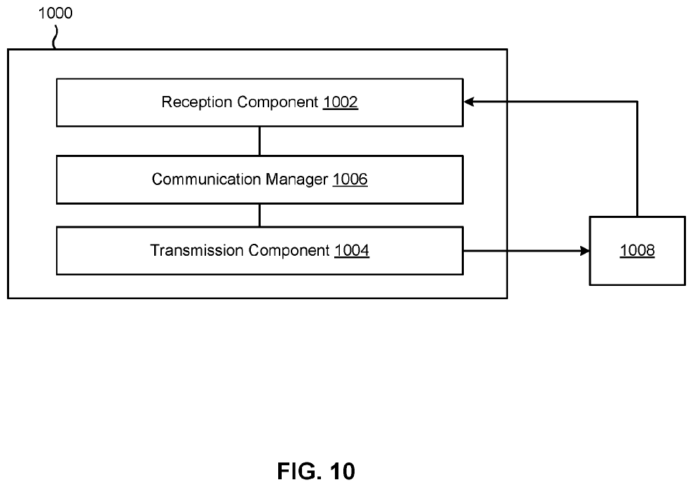

As shown in FIG. 8, in some aspects, process 800 may include outputting or configuring a first grant of resources allocating a plurality of scanning directions and a first plurality of tracking directions (block 810). For example, the network entity (e.g., using transmission component 1004 and/or communication manager 1006, depicted in FIG. 10) may output or configure a first grant of resources allocating a plurality of scanning directions and a first plurality of tracking directions, as described above.

As further shown in FIG. 8, in some aspects, process 800 may include receiving a resource modification request (block 820). For example, the network entity (e.g., using reception component 1002 and/or communication manager 1006, depicted in FIG. 10) may receive a resource modification request, as described above.

As further shown in FIG. 8, in some aspects, process 800 may include outputting or configuring a second grant of resources allocating a second plurality of tracking directions, wherein the second plurality of tracking directions is a subset of the plurality of scanning directions different from the first plurality of tracking directions (block 830). For example, the network entity (e.g., using transmission component 1004 and/or communication manager 1006, depicted in FIG. 10) may output or configure a second grant of resources allocating a second plurality of tracking directions, wherein the second plurality of tracking directions is a subset of the plurality of scanning directions different from the first plurality of tracking directions, as described above.

Process 800 may include additional aspects, such as any single aspect or any combination of aspects described below and/or in connection with one or more other processes described elsewhere herein.

In a first aspect, the second plurality of tracking directions includes one or more tracking directions associated with an estimated object location.

In a second aspect, alone or in combination with the first aspect, process 800 includes receiving an indication of a number of targets identified.

In a third aspect, alone or in combination with one or more of the first and second aspects, process 800 includes receiving an indication of a list of targets identified.

In a fourth aspect, alone or in combination with one or more of the first through third aspects, the indication of the list of targets includes a respective corresponding beam index for each target in the list of targets.

In a fifth aspect, alone or in combination with one or more of the first through fourth aspects, process 800 includes receiving a respective estimated object location associated with each target of one or more targets identified.

In a sixth aspect, alone or in combination with one or more of the first through fifth aspects, process 800 includes receiving respective estimated velocity information associated with each target of one or more targets identified.

In a seventh aspect, alone or in combination with one or more of the first through sixth aspects, the first grant of resources allocates one scanning direction per frame.

In an eighth aspect, alone or in combination with one or more of the first through seventh aspects, the resource modification request identifies one or more resources, of the first grant of resources, to be excluded from the second grant of resources.

In a ninth aspect, alone or in combination with one or more of the first through eighth aspects, the one or more resources to be excluded from the second grant of resources include one or more resources associated with one or more tracking directions of the first plurality of tracking directions.

In a tenth aspect, alone or in combination with one or more of the first through ninth aspects, the resource modification request identifies the one or more resources to be excluded from the second grant of resources according to a frame number.

In an eleventh aspect, alone or in combination with one or more of the first through tenth aspects, the resource modification request identifies the one or more resources to be excluded from the second grant of resources according to a beam number.

In a twelfth aspect, alone or in combination with one or more of the first through eleventh aspects, the resource modification request identifies the one or more resources to be excluded from the second grant of resources according to a frame number and beam pair.

In a thirteenth aspect, alone or in combination with one or more of the first through twelfth aspects, the resource modification request identifies one or more resources, of the first grant of resources, to be included in the second grant of resources.

In a fourteenth aspect, alone or in combination with one or more of the first through thirteenth aspects, the one or more resources to be included in the second grant of resources include one or more resources associated with one or more tracking directions not included in the first plurality of tracking directions.

In a fifteenth aspect, alone or in combination with one or more of the first through fourteenth aspects, the resource modification request identifies the one or more resources to be included in the second grant of resources according to a frame number.

In a sixteenth aspect, alone or in combination with one or more of the first through fifteenth aspects, the resource modification request identifies the one or more resources to be included in the second grant of resources according to a beam number.

In a seventeenth aspect, alone or in combination with one or more of the first through sixteenth aspects, the resource modification request identifies the one or more resources to be included in the second grant of resources according to a frame number and beam pair.

In an eighteenth aspect, alone or in combination with one or more of the first through seventeenth aspects, the second plurality of tracking directions includes each resource of the first plurality of tracking directions and at least one other tracking direction, of the plurality of scanning directions, not included in the first plurality of tracking directions.

In a nineteenth aspect, alone or in combination with one or more of the first through eighteenth aspects, process 800 includes receiving a negative acknowledgement prior to receiving the resource modification request and prior to outputting or configuring the second grant of resources.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a first grant of resources allocating a plurality of scanning directions and a first plurality of tracking directions. The transmission component 904 may transmit a resource modification request. The reception component 902 may receive a second grant of resources allocating a second plurality of tracking directions, wherein the second plurality of tracking directions is a subset of the plurality of scanning directions and are different from the first plurality of tracking directions.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network entity, or a network entity may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may output or configure a first grant of resources allocating a plurality of scanning directions and a first plurality of tracking directions. The reception component 1002 may receive a resource modification request. The transmission component 1004 may output or configure a second grant of resources allocating a second plurality of tracking directions, wherein the second plurality of tracking directions is a subset of the plurality of scanning directions and are different from the first plurality of tracking directions.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: receiving a first grant of resources allocating a plurality of scanning directions and a first plurality of tracking directions; transmitting a resource modification request; and receiving a second grant of resources allocating a second plurality of tracking directions, wherein the second plurality of tracking directions is a subset of the plurality of scanning directions different from the first plurality of tracking directions.

Aspect 2: The method of Aspect 1, further comprising transmitting a first sensing waveform in each of the plurality of scanning directions to determine an estimated object location.

Aspect 3: The method of Aspect 2, further comprising generating the resource modification request based at least in part on the estimated object location.

Aspect 4: The method of Aspect 3, wherein the second plurality of tracking directions includes one or more tracking directions associated with the estimated object location.

Aspect 5: The method of Aspect 2, further comprising transmitting an indication of a number of targets identified by the first sensing waveform.

Aspect 6: The method of Aspect 2, further comprising transmitting an indication of a list of targets identified by the first sensing waveform.

Aspect 7: The method of Aspect 6, wherein the indication of the list of targets includes a respective corresponding beam index for each target in the list of targets.

Aspect 8: The method of Aspect 2, further comprising transmitting a respective estimated object location associated with each target of one or more targets identified by the first sensing waveform.

Aspect 9: The method of Aspect 2, further comprising transmitting respective estimated velocity information associated with each target of one or more targets identified by the first sensing waveform.

Aspect 10: The method of Aspect 2, further comprising transmitting a second sensing waveform in each of the second plurality of tracking directions.

Aspect 11: The method of any of Aspects 1-10, wherein the first grant of resources allocates one scanning direction per frame.

Aspect 12: The method of any of Aspects 1-11, wherein the resource modification request identifies one or more resources, of the first grant of resources, to be excluded from the second grant of resources.

Aspect 13: The method of Aspect 12, wherein the one or more resources to be excluded from the second grant of resources include one or more resources associated with one or more tracking directions of the first plurality of tracking directions.

Aspect 14: The method of Aspect 12, wherein the resource modification request identifies the one or more resources to be excluded from the second grant of resources according to a frame number.

Aspect 15: The method of Aspect 12, wherein the resource modification request identifies the one or more resources to be excluded from the second grant of resources according to a beam number.

Aspect 16: The method of Aspect 12, wherein the resource modification request identifies the one or more resources to be excluded from the second grant of resources according to a frame number and beam pair.

Aspect 17: The method of any of Aspects 1-16, wherein the resource modification request identifies one or more resources, of the first grant of resources, to be included in the second grant of resources.

Aspect 18: The method of Aspect 17, wherein the one or more resources to be included in the second grant of resources include one or more resources associated with one or more tracking directions not included in the first plurality of tracking directions.

Aspect 19: The method of Aspect 17, wherein the resource modification request identifies the one or more resources to be included in the second grant of resources according to a frame number.

Aspect 20: The method of Aspect 17, wherein the resource modification request identifies the one or more resources to be included in the second grant of resources according to a beam number.

Aspect 21: The method of Aspect 17, wherein the resource modification request identifies the one or more resources to be included in the second grant of resources according to a frame number and beam pair.

Aspect 22: The method of any of Aspects 1-21, wherein the second plurality of tracking directions includes each tracking direction of the first plurality of tracking directions and at least one other tracking direction, of the plurality of scanning directions, not included in the first plurality of tracking directions.

Aspect 23: The method of any of Aspects 1-22, further comprising transmitting a negative acknowledgement prior to transmitting the resource modification request.

Aspect 24: A method of wireless communication performed by a network entity, comprising: outputting or configuring a first grant of resources allocating a plurality of scanning directions and a first plurality of tracking directions; receiving a resource modification request; and outputting or configuring a second grant of resources allocating a second plurality of tracking directions, wherein the second plurality of tracking directions is a subset of the plurality of scanning directions different from the first plurality of tracking directions.

Aspect 25: The method of Aspect 24, wherein the second plurality of tracking directions includes one or more tracking directions associated with an estimated object location.

Aspect 26: The method of any of Aspects 24-25, further comprising receiving an indication of a number of targets identified.

Aspect 27: The method of any of Aspects 24-26, further comprising receiving an indication of a list of targets identified.

Aspect 28: The method of Aspect 27, wherein the indication of the list of targets includes a respective corresponding beam index for each target in the list of targets.

Aspect 29: The method of any of Aspects 24-28, further comprising receiving a respective estimated object location associated with each target of one or more targets identified.

Aspect 30: The method of any of Aspects 24-29, further comprising receiving respective estimated velocity information associated with each target of one or more targets identified.

Aspect 31: The method of any of Aspects 24-30, wherein the first grant of resources allocates one scanning direction per frame.

Aspect 32: The method of any of Aspects 24-31, wherein the resource modification request identifies one or more resources, of the first grant of resources, to be excluded from the second grant of resources.

Aspect 33: The method of Aspect 32, wherein the one or more resources to be excluded from the second grant of resources include one or more resources associated with one or more tracking directions of the first plurality of tracking directions.

Aspect 34: The method of Aspect 32, wherein the resource modification request identifies the one or more resources to be excluded from the second grant of resources according to a frame number.

Aspect 35: The method of Aspect 32, wherein the resource modification request identifies the one or more resources to be excluded from the second grant of resources according to a beam number.

Aspect 36: The method of Aspect 32, wherein the resource modification request identifies the one or more resources to be excluded from the second grant of resources according to a frame number and beam pair.

Aspect 37: The method of any of Aspects 24-36, wherein the resource modification request identifies one or more resources, of the first grant of resources, to be included in the second grant of resources.

Aspect 38: The method of Aspect 37, wherein the one or more resources to be included in the second grant of resources include one or more resources associated with one or more tracking directions not included in the first plurality of tracking directions.

Aspect 39: The method of Aspect 37, wherein the resource modification request identifies the one or more resources to be included in the second grant of resources according to a frame number.

Aspect 40: The method of Aspect 37, wherein the resource modification request identifies the one or more resources to be included in the second grant of resources according to a beam number.

Aspect 41: The method of Aspect 37, wherein the resource modification request identifies the one or more resources to be included in the second grant of resources according to a frame number and beam pair.

Aspect 42: The method of any of Aspects 24-41, wherein the second plurality of tracking directions includes each resource of the first plurality of tracking directions and at least one other tracking direction, of the plurality of scanning directions, not included in the first plurality of tracking directions.

Aspect 43: The method of any of Aspects 24-42, further comprising receiving a negative acknowledgement prior to receiving the resource modification request and prior to outputting or configuring the second grant of resources.

Aspect 44: An apparatus for wireless communication at a device, comprising a processor; memory coupled with the processor; and instructions stored in the memory and executable by the processor to cause the apparatus to perform the method of one or more of Aspects 1-43.

Aspect 45: A device for wireless communication, comprising a memory and one or more processors coupled to the memory, the one or more processors configured to perform the method of one or more of Aspects 1-43.

Aspect 46: An apparatus for wireless communication, comprising at least one means for performing the method of one or more of Aspects 1-43.

Aspect 47: A non-transitory computer-readable medium storing code for wireless communication, the code comprising instructions executable by a processor to perform the method of one or more of Aspects 1-43.

Aspect 48: A non-transitory computer-readable medium storing a set of instructions for wireless communication, the set of instructions comprising one or more instructions that, when executed by one or more processors of a device, cause the device to perform the method of one or more of Aspects 1-43.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE), comprising:
a transceiver;
at least one memory comprising instructions; and
one or more processors configured to execute the instructions to cause the UE to:
receive, via the transceiver, a first grant of resources allocating a plurality of scanning directions and a first plurality of tracking directions;
transmit, via the transceiver, a resource modification request; and
receive, via the transceiver, a second grant of resources allocating a second plurality of tracking directions, wherein the second plurality of tracking directions is a subset of the plurality of scanning directions different from the first plurality of tracking directions.

2. The UE of claim 1, wherein the one or more processors are further configured to cause the UE to transmit, via the transceiver, a first sensing waveform in each of the plurality of scanning directions to determine an estimated object location.

3. The UE of claim 2, wherein the one or more processors are further configured to cause the UE to generate the resource modification request based at least in part on the estimated object location.

4. The UE of claim 3, wherein the second plurality of tracking directions includes one or more tracking directions associated with the estimated object location.

5. The UE of claim 2, wherein the one or more processors are further configured to cause the UE to transmit, via the transceiver, an indication of a number of targets identified by the first sensing waveform.

6. The UE of claim 2, wherein the one or more processors are further configured to cause the UE to transmit, via the transceiver, an indication of a list of targets identified by the first sensing waveform.

7. The UE of claim 6, wherein the indication of the list of targets includes a respective corresponding beam index for each target in the list of targets.

8. The UE of claim 2, wherein at least one of:
the one or more processors are further configured to transmit, via the transceiver, a respective estimated object location associated with each target of one or more targets identified by the first sensing waveform;
the one or more processors are further configured to transmit, via the transceiver, respective estimated velocity information associated with each target of one or more targets identified by the first sensing waveform; or
the one or more processors are further configured to transmit, via the transceiver. a second sensing waveform in each of the second plurality of tracking directions.

9-10. (canceled)

11. The UE of claim 1, wherein at least one of:
the first grant of resources allocates one scanning direction per frame; or
the resource modification request identifies one or more resources, of the first grant of resources, to be excluded from the second grant of resources.

12. (canceled)

13. The UE of claim 11, wherein at least one of:
the one or more resources to be excluded from the second grant of resources include one or more resources associated with one or more tracking directions of the first plurality of tracking directions;
the resource modification request identifies the one or more resources to be excluded from the second grant of resources according to a frame number,
the resource modification request identifies the one or more resources to be excluded from the second grant of resources according to a beam number; or
the resource modification request identifies the one or more resources to be excluded from the second grant of resources according to a frame number and beam pair.

14-16. (canceled)

17. The UE of claim 1, wherein the resource modification request identifies one or more resources, of the first grant of resources, to be included in the second grant of resources.

18. The UE of claim 17, wherein the one or more resources to be included in the second grant of resources include one or more resources associated with one or more tracking directions not included in the first plurality of tracking directions.

19. The UE of claim 17, wherein the resource modification request identifies the one or more resources to be included in the second grant of resources according to a frame number.

20. The UE of claim 17, wherein the resource modification request identifies the one or more resources to be included in the second grant of resources according to a beam number.

21. The UE of claim 17, wherein the resource modification request identifies the one or more resources to be included in the second grant of resources according to a frame number and beam pair.

22. The UE of claim 1, wherein the second plurality of tracking directions includes each tracking direction of the first plurality of tracking directions and at least one other tracking direction, of the plurality of scanning directions, not included in the first plurality of tracking directions.

23. The UE of claim 1, wherein the one or more processors are further configured to transmit a negative acknowledgement prior to transmitting the resource modification request.

24. A network entity for wireless communication, comprising:
a transceiver;
at least one memory comprising instructions; and
one or more processors configured to execute the instructions to cause the network entity to:
output or configure a first grant of resources allocating a plurality of scanning directions and a first plurality of tracking directions;
receive a resource modification request; and
output or configure a second grant of resources allocating a second plurality of tracking, directions, wherein the second plurality of tracking directions is a subset of the plurality of scanning directions different from the first plurality of tracking directions.

25. The network entity of claim 24, wherein at least one of:
the one or more processors are further configured to cause the network entity to receive, via the transceiver, one or more of an indication of a number of targets identified or a list of targets identified;
the one or more processors are further configured to cause the network entity to receive, via the transceiver, a respective estimated object location associated with each target of one or more targets identified;
the one or more processors are further configured to cause the network entity to receive, via the transceiver, respective estimated velocity information associated with each target of one or more targets identified; or
the one or more processors are further configured to cause the network entity to receive, via the transceiver, a negative acknowledgement prior to receiving the resource modification request and prior to outputting or configuring the second grant of resources.

26-28. (canceled)

29. A method of wireless communication performed by a user equipment (UE), comprising:
receiving a first grant of resources allocating a plurality of scanning directions and a first plurality of tracking directions;
transmitting a resource modification request; and
receiving a second grant of resources allocating a second plurality of tracking directions, wherein the second plurality of tracking directions is a subset of the plurality of scanning directions different from the first plurality of tracking directions.

30. (canceled)
